(19) United States
(12) Patent Application Publication
(10) Pub. No.: US 2013/0248784 A1
(43) Pub. Date: Sep. 26, 2013

(54) Accessory Kit Apparatus and Method For One or More Heavy-Duty Floor Jack

(71) Applicant: Lester Lynn Rose, Shawnee, OK (US)

(72) Inventor: Lester Lynn Rose, Shawnee, OK (US)

(73) Assignee: Rocky's World, LLC, Shawnee, OK (US)

(21) Appl. No.: 13/430,127

(22) Filed: Mar. 26, 2012

(51) Int. Cl. B66F 3/00

(52) U.S. Cl. 254/11

(57) ABSTRACT

An accessory kit apparatus for use with a heavy-duty floor jack includes at least one extension tube with a first end configured to engage a matching mounting area of a lowering member of the floor jack and a second end. The accessory kit also includes a separable top support member having a mounting portion extending from a flat base, the mounting portion configured to engage the second end of the extension tube. The separable top support member also has a channel member and a hinge, whereby the channel member is hinged to an edge of the flat base, the channel member having rims defining a channel. The flat base supports the flat base is configured to support the channel member when the jack is in use.

### BACKGROUND OF THE INVENTION

This invention relates generally to methods and apparatus for removing a drive shaft (or differential), and more particularly to methods and apparatus for removing a drive shaft of a heavy vehicle, such as a semi-trailer truck (a “semi” or “18 wheeler”), using an accessory kit and two or more heavy-duty floor jacks, and to a floor jack suitable for such removal.

Lowering a drive shaft to remove a transmission under a semi can be a difficult task when performed by a floor jack, especially when the vehicle is heavy and no special apparatus is available to center the two drive shafts (“differentials”) on a supporting member of the jack. In at least some known embodiments of jacks, a special apparatus is required to hold a differential or transmission on the jack while the axle is lowered to prevent the vehicle from tilting dangerously to one side or the other. Many known differentials weigh approximately 200 pounds (about 90 kilograms) each. Thus, at least two people are required when lowering the differential. Moreover, the middle portion (carrier bearing) of the differential moves, tending to make the drive shafts slope down.

It would be thus desirable if a simple, portable, and adaptable apparatus existed for such lowering and removing of a drive shaft or differential.

### BRIEF DESCRIPTION OF THE INVENTION

In one aspect, some configurations of the present invention therefore provide an accessory kit apparatus for use with heavy-duty floor jacks. The accessory kit includes at least one extension tube with a first end configured to engage a matching mounting area of a lowering member of the floor jack and a second end. The accessory kit also includes a separable top support member having a mounting portion extending from a flat base, the mounting portion configured to engage the second end of the extension tube. The separable top support member also has a channel member and a hinge, whereby the channel member is hinged to an edge of the flat base, the channel member having rims defining a channel. The flat base supports the flat base is configured to support the channel member when the jack is in use.

In another aspect, some configurations of the present invention provide a lowering apparatus having a floor jack and at least one extension tube with a first end configured to engage a matching mounting area of a lowering member of the floor jack and a second end. These configurations also include a separable top support member having a mounting portion extending from a flat base. The mounting portion is configured to engage the second end of the extension tube. The mounting portion also has a channel member and a hinge, whereby the channel member is hinged to an edge of the flat base. The channel member has rims defining a channel, and the flat base is configured to support the channel member when the lowering apparatus is in use.

In still another aspect of the present invention, a method for lowering a drive shaft of a vehicle is provided. The method includes placing opposite sides of the drive shaft in channels of two lowering apparatus, one lowering apparatus supporting each side of the drive shaft, and each lowering apparatus having a hinged channel member. The method further includes using one of the lowering apparatus to lower a first of the sides of the drive shaft it is supporting, while allowing the channel member of each lowering apparatus to tilt as the first side of the drive shaft is lowered. The method also includes using the other lowering apparatus to lower the second of the sides of the drive shaft it is supporting, while allowing the channel member of each lowering apparatus to tilt as the second side of the drive shaft is lowered.

It will be appreciated that various configurations of the present invention provide one or more advantage over known methods and apparatus for lowering a drive shaft. Namely, the various configurations of the present invention provide simple means and/or methods for lowering the drive shaft by one person using a lowering apparatus. The drive shaft can be held in place while it is tilted, and the apparatus can be simple, portable, and/or adaptable to various vehicles, or any combination thereof.

### BRIEF DESCRIPTION OF THE DRAWINGS

FIG. 1 is a drawing of an embodiment of an accessory kit and a prior art heavy-duty floor jack, with a portion of the accessory kit mounted on the heavy-duty floor jack and ready for use.

FIG. 2 is a drawing of a prior art floor jack suitable for use with the accessory kit embodiment shown in FIG. 1, but shown without an accessory kit in FIG. 2.

FIG. 3 is a drawing showing the insertion of an accessory kit extension tube into a lowering member of the floor jack.

FIG. 4 is a drawing of a top support member shown in FIG. 1, but shown unassembled and upside down to illustrate certain details of the top support member.

FIG. 5 is a drawing of an assembly suitable for lowering a drive shaft, wherein the assembly comprises a portion of the accessory kit of FIG. 1 and the prior art floor jack of FIG. 2.

FIG. 6 is a drawing of an assembly similar to that of FIG. 5 except that a chain shown in FIG. 5 is shown in a securing configuration and the channel member shown in FIG. 5 is shown hinged from a horizontal position. In addition, ribs on an extension tube are also shown.

FIG. 7 is a drawing showing how a pair of extension tubes can be used with a joining member to create an assembly that can be used to mount a top support member at a height greater than that possible using only a single extension tube.

FIG. 8 is a drawing showing supporting ribs of an extension tube.

FIG. 9 is a drawing showing a pair of lowering apparatus supporting a portion of a drive shaft in a tilted, non-horizontal position, as would occur during a portion of the time a drive shaft of the vehicle is lowered during performance of some method embodiments of the present invention.

The foregoing summary, as well as the following detailed description of certain embodiments of the present invention, will be better understood when read in conjunction with the appended drawings.

### DETAILED DESCRIPTION OF THE INVENTION

As used herein, an element or step recited in the singular and proceeded with the word “a” or “an” should be understood as not excluding plural said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

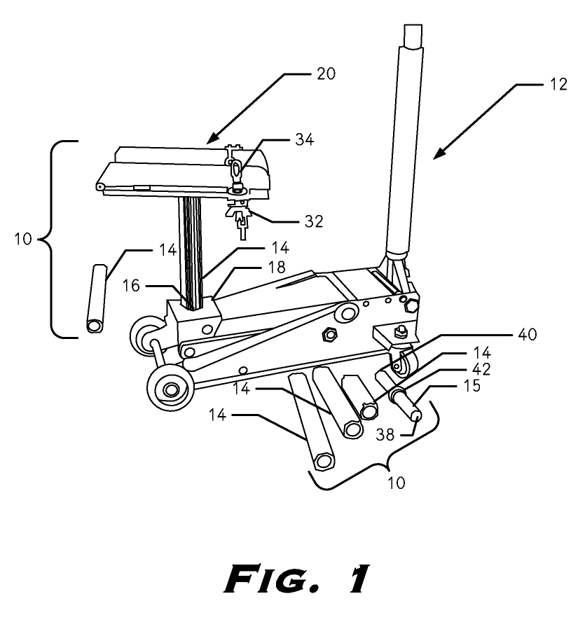

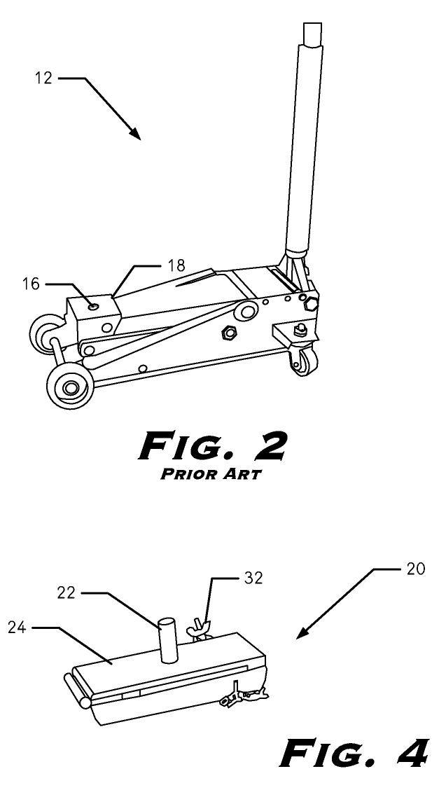

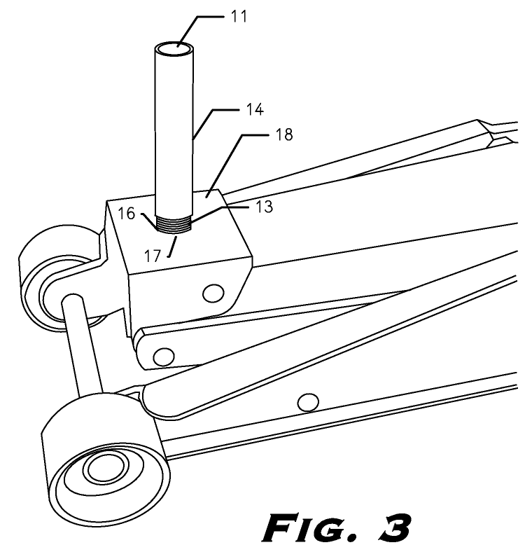

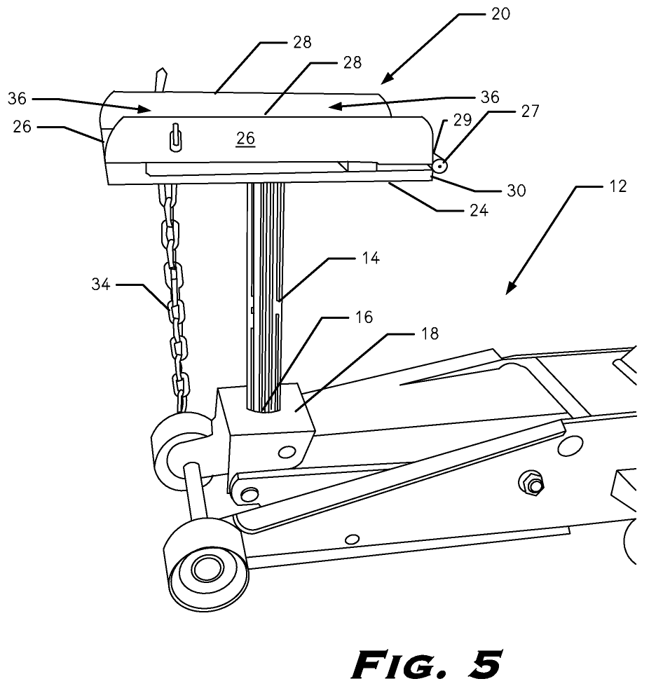

Referring now to FIG. 1 and FIG. 2, some embodiments of the present invention provide an accessory kit apparatus 10 for use with (or including), e.g., a prior art floor jack 12 (e.g., a heavy-duty floor jack 12 of a type that may be originally intended to raise a vehicle by an axle). The kit 10 includes one or more extension tubes 14 that are configured to engage a matching mounting area 16 of a lowering member 18 of the floor jack 12. For example, in some embodiments and referring to FIG. 3, the one or more extension tubes 14 have threads 13 so that they can be screwed firmly into a matching threaded hole 16 in the lowering member 18. Referring to FIG. 1 and FIG. 4, the accessory kit 10 also includes a separable top support member 20. The top support member 20 includes a mounting portion 22 extending from its base 24, which may be a flat base. The mounting portion 22 is configured to engage an end 11 of an extension tube 14 opposite an end 17 engaged with the lowering member 18. For example, in some embodiments, the extension tube 14 is essentially cylindrical and the mounting portion 22 is a rod-like portion extending at right angles from the bottom of the base 24 and dimensioned to fit within the cylindrical hole at end 11 of the extension tube 14.

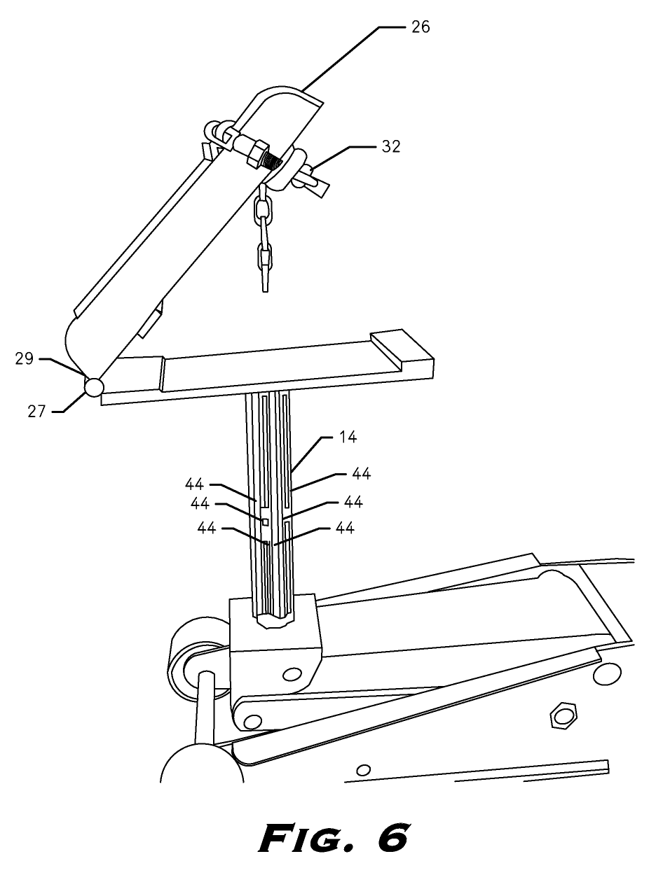

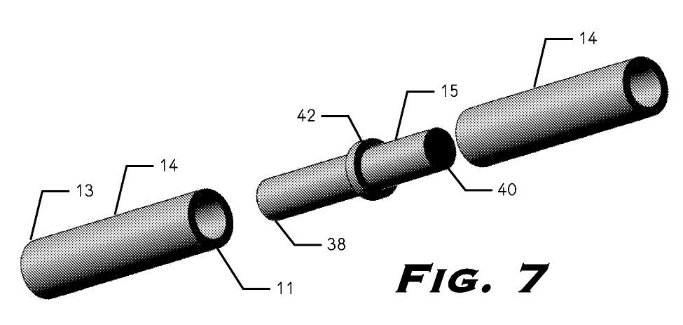

In addition to its base 24 and referring now to FIG. 5, the top support member 20 further includes a channel member 26 having upwardly extending rims 28 that define a channel 36 in which an axle (not shown in FIG. 5, but, e.g., an axle of a heavy vehicle) can be supported. The channel member 26 is itself hinged via a hinge 27 to an edge 30 of the base 24. In some embodiments, the rims 28 of the channel member 26 are on edges of channel member 26 that are at right angles to the hinged edge 29 of channel member 26. The base 24 supports the channel member 26 when the floor jack 12 is in use and when the accessory kit 10 is used. When the drive shaft is horizontal, the channel member 26 itself is also horizontal, and the base 24 is fully supported by the channel member 26. When the drive shaft is at an angle to horizontal, the channel member 26 tilts accordingly relative to base 24, and is supported by the base 24 via at least the hinge 27. An illustration of a tilted channel member 26 is shown in FIG. 6, although the amount of tilting in actual use may be somewhat less than in many instances than is illustrated.

In some embodiments, the separable top support member 20 further includes an attached securing member 34 (for example, an attached chain) that is configured to hold a drive shaft in place within the channel 36 of the channel member 26. For example and referring to FIG. 1 and FIG. 5, the attached securing member 34 or chain can be wrapped over the top of the rims 28 of the channel member 26 and over the drive shaft in the channel 36 when the drive shaft (not shown in FIG. 1 or in FIG. 5) is in the channel 36. If a chain is used as securing member 34, for example, the chain can be tightened around the drive shaft and channel member 26 using a tightening mechanism 32 such as a bolt, wing nut, and/or lock.

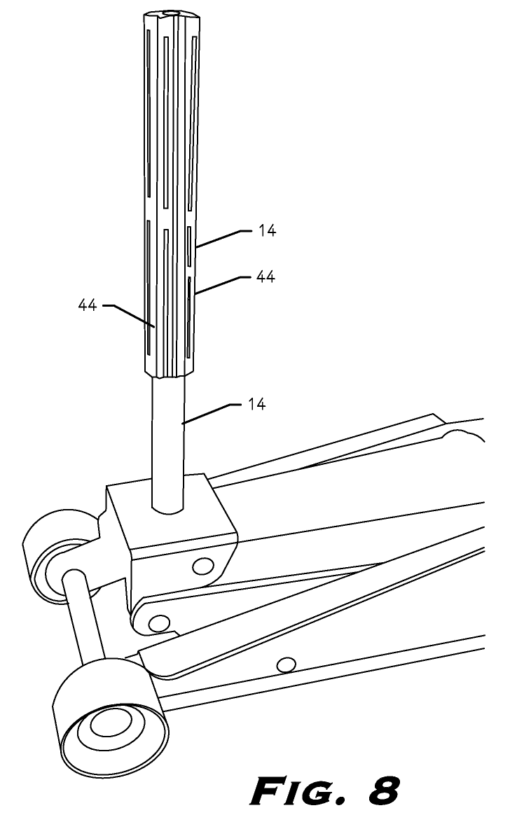

In some embodiments and referring again to FIG. 1, to allow a greater range of operability, a plurality of extension tubes 14 of differing length are provided in an extension kit 10. Some embodiments also provide one or more joining members 15 that is/are suitably configured to connect two extension tubes 14 to provide an even greater range of operating lengths. For example, extension tubes 14 are cylindrical in some configurations. In other configurations, extension tubes 14 have longitudinal ribs or are otherwise shaped or configured to reduce or eliminate the likelihood of extension tubes 14 from rolling away so that a person under a truck assembling the extension kit need not worry about getting up to fetch an extension tube 14 that has rolled out of reach. A joining member 15 comprising a rod or cylinder having opposite ends 38, 40 and a circumferential rib 42 between the opposite ends 38, 40 is also provided. The circumferential rib 42 is of sufficient diameter to support the joining member 15 at the height of the circumferential rib 42 at the end 11 (see FIG. 3) of an extension tube 14, In some embodiments and referring also to FIG. 7, the circumferential rib 42 is located on the joining member 15 in a position such that one of the ends 38 of the joining member 15 can be inserted in one extension tube 14 and the other end 40 of the joining member 15 is available to insert in a second extension tube 14. This embodiment allows the separable top support member 20 to be supported at at least three different heights instead of two without having to provide an extension tube 14 representing the greatest height. In embodiments with more than two extension tubes 14, or in embodiments in which circumferential rib 42 is not located equidistant from opposite ends 38 and 40, an even greater variety of heights can be made available.

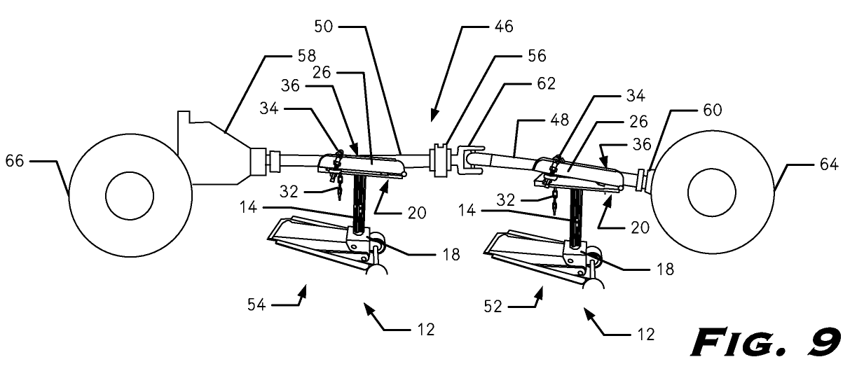

In some embodiments and referring to FIG. 6 and FIG. 8, all or some of the extension tubes 14 themselves can be reinforced to strengthen them and to allow them to support greater weights than would be possible without reinforcement. Also, in some embodiments, extension tubes 14 can have longitudinal ridges or ribs 44 to help prevent extension tubes 14 from rolling away if dropped. Thus, a mechanic would not have to get out from under the semi to retrieve a dropped tube that rolls across the floor.

Some configurations of the present invention provide two accessory kits to fit on two floor jacks, as many uses of the accessory kit will be in conjunction with the use of jacks on both sides of a differential of a heavy vehicle. Still other configurations include both the accessory kit and one or more floor jacks in combination. In general, kits may be marketed with enough accessory parts for one floor jack, or for more than one floor jack, and the kits may be marketed with or without one or more floor jacks, to allow unequipped or partially equipped shops flexibility in purchasing kits for their specific needs or as replacement parts if needed.

In some embodiments and referring to FIG. 9, a method for lowering a drive shaft 46 of a vehicle (represented by left side front wheel 66 and driven left side rear wheel 64) is provided. This method includes placing opposite sides 48, 50 of the drive shaft 46 (separated by bearing assembly 56 and universal joint 62 in the illustrated configuration) in the channels 36 of two lowering apparatus 52, 54, one supporting each side of drive shaft 46. (Lowering apparatus 52 and 54 are shown only in part, and not necessarily to scale. The wheels of lowering apparatus 52 and 54 would, in most configurations, be on a level floor, as would left side front wheel 66 and driven left side rear wheel 64.) By “opposite sides,” it is meant, for example, that one lowering apparatus 52 lowers a side 48 of the drive shaft 46 between bearing assembly 56 and universal joint 62 and a differential 60, while the other lowering apparatus 54 lowers a side 50 of the drive shaft 46 between a transmission 58 and the bearing assembly 56 and the universal joint 62. Thus, sides 48, 50 of the drive shaft 46 are on opposite sides of the bearing assembly 56 and the universal joint 62. Each lowering apparatus 52, 54 has a hinged channel member 26 supporting a corresponding portion 48, 50 of drive shaft 46. Drive shaft 46 is separated from transmission 58 and differential 60. A first lowering apparatus 52 of the two lowering apparatus 52, 54 is then used (e.g., pumped down) to lower the side 48 of the drive shaft 46 it is supporting. In the process of lowering the drive shaft, the drive shaft 46 will tilt away from the horizontal, as in FIG. 9, but the channel member 26 of each lowering apparatus is hinged. Thus, the channel member 26 of each lowering apparatus 52, 54 is allowed to tilt as the first side 48 of the drive shaft 46 is lowered. The other lowering apparatus 54 is then used to lower the side 50 of the drive shaft 46 it is supporting. The lowering of the drive shaft 46 by the other lowering apparatus 54 will also cause the drive shaft 46 to tilt, this time towards the horizontal (or to, or even past horizontal). The channel members 26 of each of the lowering apparatus 52, 54 are allowed to tilt during this phase of lowering as well. In this manner, the drive shaft 46 can be quickly and efficiently lowered without the use of heavier and/or more expensive, heavy, or exotic lowering machines.

In some embodiments of the present invention, the drive shaft 46 is secured to each hinged channel member 26, for example, by tightening securing members 34 such as chains around the drive shaft 46 while it is resting in the channels 36 of each channel member 26. Also in some embodiments of the present invention, a height of a top support member 20 above the ground is selected by engaging an extension tube 14, or a combination of extension tubes 14 and/or joining members 15 (not shown in FIG. 9, but shown in FIG. 7) with a lowering member 18 of each floor jack 12, and placing a separable top support member 20 at the top of the extension tube 14 or combination of extension tubes 14 and/or joining members 15 (not shown in FIG. 9 but shown in FIG. 7).

To summarize, an accessory kit for a heavy-duty floor jack is advantageously provided in some embodiments of the present invention. The accessory kit includes at least one threaded extension tube configured to mount in a matching threaded hole in a lowering member of the floor jack. In some embodiments, a plurality of extension tubes are provided that may be mounted individually or in combination to achieve a desired height for a separable top support member. The separable top support member includes a mounting portion extending from a flat base, wherein when the jack is in use, the mounting portion fits within or around an extension tube mounted in the hole in the lowering member of the floor jack. A channel member is hinged to an edge of the flat base. The channel member has upwardly extending rims on edges at right angles to the hinged edge. The flat base supports the channel member when the jack is in use. Two such jacks with accessories can support a drive shaft on each side. Because the jacks will not necessarily be at equal height, the drive shaft may be tilted at times. When the drive shaft is tilted, the hinge moves in response thereto to allow the jack to better support the drive shaft than would be the case if there were no hinge and the drive shaft were supported by a member level to the ground. A chain attached to the top support member is provided that can be used to hold the drive shaft in place in the channel.

While the invention has been described in terms of various specific embodiments, those skilled in the art will recognize that the invention can be practiced with modification within the spirit and scope of the claims.

What is claimed is:

1. An accessory kit apparatus for use with a heavy-duty floor jack, the accessory kit comprising:
at least one extension tube with a first end configured to engage a matching mounting area of a lowering member of the floor jack and a second end; and
a separable top support member having a mounting portion extending from a flat base, the mounting portion configured to engage the second end of the extension tube, and also having a channel member and a hinge, whereby the channel member is hinged to an edge of the flat base, the channel member having rims defining a channel, and wherein the flat base is configured to support the channel member when the jack is in use.

2. An accessory kit apparatus in accordance with claim 1 wherein the separable top support member further comprises an attached securing member configured to hold a portion of a drive shaft in place within the channel.

3. An accessory kit apparatus in accordance with claim 1 wherein the hinge is configured to allow the channel member to tilt in response to the tilting of the portion of a drive shaft supported in the channel when the drive shaft is tilted.

4. An accessory kit apparatus in accordance with claim 3 wherein the separable top support member further comprises an attached securing member configured to hold the portion of the drive shaft in place within the channel.

5. Two accessory kit apparatus in accordance with claim 1 provided to allow for use on two floor jacks lowering opposite sides of a drive shaft of a vehicle.

6. Two accessory kit apparatus in accordance with claim 5 wherein each separable top support member further comprises an attached securing member configured to hold the portion of the drive shaft in place within the channel of a corresponding said channel member.

7. Two accessory kit apparatus in accordance with claim 6 wherein each hinge is configured to allow a corresponding said channel member to tilt in response to the tilting of the portion of the drive shaft supported in the channel when the drive shaft is tilted.

8. Two accessory kit apparatus in accordance with claim 7 wherein each separable top support member further comprises an attached securing member configured to hold the portion of the drive shaft in place within the channel of a corresponding said channel member.

9. An accessory kit apparatus in accordance with claim 1 wherein the extension tube is threaded.

10. An accessory kit apparatus in accordance with claim 9 further comprising a joining member configured to engage one said extension tube on each side of the joining member.

11. An accessory kit apparatus in accordance with claim 10 wherein the extension tube is configured to resist rolling when dropped.

12. A lowering apparatus comprising:
a floor jack;
at least one extension tube with a first end configured to engage a matching mounting area of a lowering member of the floor jack and a second end; and
a separable top support member having a mounting portion extending from a flat base, the mounting portion configured to engage the second end of the extension tube, and also having a channel member and a hinge, whereby the channel member is hinged to an edge of the flat base, the channel member having upwardly extending rims defining a channel, and wherein the flat base is configured to support the channel member when the lowering apparatus is in use.

13. A lowering apparatus in accordance with claim 12 wherein the separable top support member further comprises an attached securing member configured to hold a portion of a drive shaft in place within the channel.

14. A lowering apparatus in accordance with claim 13 wherein the hinge is configured to allow the channel member to tilt in response to the tilting of the portion of the drive shaft supported in the channel when the drive shaft is tilted.

15. A lowering apparatus in accordance with claim 14 wherein the separable top support member further comprises an attached securing member configured to hold the portion of the drive shaft in place within the channel.

16. Two lowering apparatus in accordance with claim 12 provided to allow for use in lowering opposite sides of a drive shaft of a vehicle.

17. Two lowering apparatus in accordance with claim 16 wherein each hinge is configured to allow a corresponding said channel member to tilt in response to the tilting of the portion of the drive shaft supported in the channel between the upwardly extending rims when the drive shaft is tilted.

18. Two lowering apparatus in accordance with claim 17 wherein each hinge is configured to allow the corresponding said channel member to tilt in response to the tilting of the portion of the drive shaft supported in the channel when the drive shaft is tilted.

19. A method for lowering a drive shaft of a vehicle, the method comprising:
placing opposite sides of the drive shaft in channels of two lowering apparatus, one lowering apparatus supporting each side of the drive shaft, and each lowering apparatus having a hinged channel member;
using one of the lowering apparatus to lower a first of said sides of the drive shaft it is supporting, while allowing the channel member of each lowering apparatus to tilt as the first of said sides of the drive shaft is lowered; and
using a second of the lowering apparatus to lower a second of said sides of the drive shaft it is supporting, while allowing the channel member of each lowering apparatus to tilt as the second of said sides of the drive shaft is lowered.

20. A method in accordance with claim 19 further comprising securing the drive shaft in each said hinged channel member.
